(19) United States
(12) Patent Application Publication
(10) Pub. No.: US 2025/0355989 A1
(43) Pub. Date: Nov. 20, 2025

(54) SECURITY SYSTEM AND SECURITY METHOD

(71) Applicants: NEC Corporation, Tokyo (JP); Cyber Defense Institute, Inc., Tokyo (JP)

(72) Inventors: Atsushi NAGATA, Tokyo (JP); Toru TOMITA, Tokyo (JP)

(73) Assignees: NEC Corporation, Tokyo (JP); Cyber Defense Institute, Inc., Tokyo (JP)

(21) Appl. No.: 19/203,302

(22) Filed: May 9, 2025

(30) Foreign Application Priority Data
May 14, 2024 (JP) 2024-078627

(51) Int. Cl. G06F 21/44; G06F 21/31

(52) U.S. Cl. CPC G06F 21/44; G06F 21/31

(57) ABSTRACT

A security system according to an aspect of the present disclosure includes: at least one memory storing a set of instructions; and at least one processor configured to execute the set of instructions to: verify device authenticity by using verification information, the device authenticity being authenticity of hardware of an information processing device that achieves a virtual computer, the verification information being generated from information about starting up of the information processing device; and instruct a communication control device that controls communication from the virtual computer to set a communication partner of the virtual computer to a decoy network in a case where the device authenticity is not verified, the decoy network mimicking a connection destination of the virtual computer.

This application is based upon and claims the benefit of priority from Japanese Patent Application No. 2024-078627, filed on May 14, 2024, the disclosure of which is incorporated herein in its entirety by reference.

### TECHNICAL FIELD

The present disclosure relates to a security system and a security method.

### BACKGROUND ART

JP 2014-518428 A describes a method of verifying initialization firmware and a basic input output system (BIOS) according to at least one of power on and reset. The method of JP 2014-518428 A includes, when the verification of either the initialization firmware or the BIOS fails, at least one of not executing the BIOS, starting repair, reporting the verification failure, stopping, shutting down, and executing the BIOS to boot the OS with limited functions.

### SUMMARY

An object of the present disclosure is to provide a security system, a security method, and a program capable of guiding an attack to an environment in which the attack by an attacker can be observed while preventing the attack by the attacker.

A security system according to an aspect of the present disclosure includes: at least one memory storing a set of instructions; and at least one processor configured to execute the set of instructions to: verify device authenticity by using verification information, the device authenticity being authenticity of hardware of an information processing device that achieves a virtual computer, the verification information being generated from information about starting up of the information processing device; and instruct a communication control device that controls communication from the virtual computer to set a communication partner of the virtual computer to a decoy network in a case where the device authenticity is not verified, the decoy network imitating a connection destination of the virtual computer.

A security method according to an aspect of the present disclosure includes: verifying device authenticity by using verification information, the device authenticity being authenticity of hardware of an information processing device that achieves a virtual computer, the verification information being generated from information about starting up of the information processing device; and instructing a communication control device that controls communication from the virtual computer to set a communication partner of the virtual computer to a decoy network in a case where the device authenticity is not verified, the decoy network imitating a connection destination of the virtual computer.

A security system according to an aspect of the present disclosure includes: at least one memory storing a set of instructions; and at least one processor configured to execute the set of instructions to: verify device authenticity using verification information, the device authenticity being authenticity of hardware of an information processing device that achieves a virtual computer, the verification information being generated from information about starting up of the information processing device; and set a communication partner of the virtual computer to a decoy network in a case where the device authenticity is not verified, the decoy network imitating a connection destination of the virtual computer.

### BRIEF DESCRIPTION OF THE DRAWINGS

FIG. 1 is a block diagram illustrating an example of a configuration of a security system according to the present disclosure;

FIG. 2 is a flowchart illustrating an example of an operation of the security system according to the present disclosure;

FIG. 3 is a block diagram illustrating an example of a configuration of a security system according to the present disclosure;

FIG. 4 is a block diagram illustrating an example of a configuration of an information processing device according to the present disclosure;

FIG. 5 is a block diagram illustrating an example of a configuration of a security system according to the present disclosure;

FIG. 6 is a block diagram illustrating an example of a configuration of a security system according to the present disclosure;

FIG. 7 is a flowchart illustrating an example of an operation of the security system according to the present disclosure;

FIG. 8 is a flowchart illustrating an example of an operation of a device starting up process of the security system according to the present disclosure;

FIG. 9 is a flowchart illustrating an example of an operation of a monitoring start process of the security system according to the present disclosure;

FIG. 10 is a flowchart illustrating an example of an operation of an authentication process of the security system according to the present disclosure;

FIG. 11 is a flowchart illustrating an example of an operation of a monitoring determination process of the security system according to the present disclosure;

FIG. 12 is a flowchart illustrating an example of an operation of a process of storing OS information in the security system according to the present disclosure;

FIG. 13 is a flowchart illustrating an example of an operation of a process of restoring OS information in the security system according to the present disclosure;

FIG. 14 is a block diagram illustrating an example of a configuration of a security system according to the present disclosure;

FIG. 15 is a block diagram schematically illustrating an example of a configuration of a security system according to the present disclosure;

FIG. 16 is a block diagram illustrating an example of a configuration of a security system according to the present disclosure;

FIG. 17 is a flowchart illustrating an example of an operation of the security system according to the present disclosure; and

FIG. 18 is a diagram illustrating an example of a hardware configuration of a computer that can implement the security system according to the example embodiment of the present disclosure.

### EXAMPLE EMBODIMENT

Hereinafter, example embodiments of the present disclosure will be described in detail using the drawings. In the drawings of the present disclosure, lines connecting the components represent that there is data exchange between the components. The components between which data is exchanged are not limited to the components connected by lines. Data may also be exchanged between components not connected by lines.

### First Example Embodiment

First, the first example embodiment of the present disclosure will be described in detail with reference to the drawings.

### Configuration

First, a configuration of the first example embodiment of the present disclosure will be described in detail with reference to the drawings.

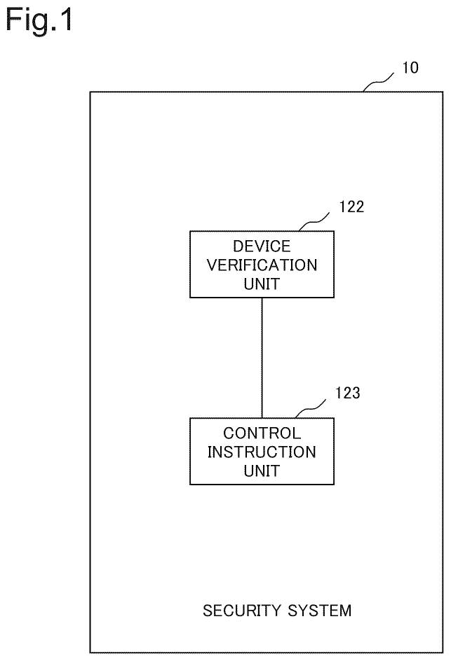

FIG. 1 is a block diagram illustrating an example of a configuration of a security system according to the present disclosure.

Hereinafter, a configuration of a security system according to the first example embodiment of the present disclosure will be described in detail with reference to FIG. 1.

In the example illustrated in FIG. 1, security system 10 according to the first example embodiment of the present disclosure includes a device verification unit 122 and a control instruction unit 123.

### <Device Verification Unit 122>

The device verification unit 122 verifies the device authenticity, which is the authenticity of the hardware of the information processing device that achieves the virtual computer, using the verification information generated from the information about starting up of the information processing device.

### <Control Instruction Unit 123>

In a case where the device authenticity is not verified, the control instruction unit 123 instructs a communication control device that controls communication from the virtual computer to set a communication partner of the virtual computer to a decoy network that mimics a connection destination of the virtual computer.

### Supplementary Description

The information about starting up of the information processing device is, for example, software such as a boot loader and firmware executed at the time of starting up of the information processing device. The information about starting up of the information processing device may include, for example, parameters of software such as a boot loader and firmware executed at the time of starting up of the information processing device. The information about starting up of the information processing device may include, for example, a boot sequence (for example, information about the order of executed boot loader and software such as firmware) at the time of starting up of the information processing device. The information about starting up of the information processing device may include other information related to software (in other words, the process) executed at the time of starting up of the information processing device.

The verification information generated from the information about starting up of the information processing device is, for example, a hash value of the information about starting up of the information processing device.

The device verification unit 122 may verify the device authenticity by comparing the registration verification information with verification information (hereinafter, referred to as target verification information) generated from information about starting up of the information processing device, the verification information being obtained at the time of starting up of the information processing device. The registration verification information is verification information generated from information about starting up of the information processing device in a case where the information processing device is normal. The information about starting up of the information processing device in a case where the information processing device is normal is, for example, information about starting up of the information processing device at the time of shipment. The information about starting up of the information processing device in a case where the information processing device is normal may be, for example, information about starting up of the information processing device confirmed to be normal.

The registration verification information is prepared in advance.

In a case where the target verification information and the registration verification information are the same, the device verification unit 122 may determine that the device authenticity of the information processing device has been verified. In this case, in a case where the target verification information and the registration verification information are different, the device verification unit 122 determines that the device authenticity of the information processing device is not verified. The device authenticity being verified means that, for example, it is confirmed that there is no tampering in software executed when the information processing device is started up.

For example, the device verification unit 122 may verify the device authenticity of the information processing device by transmitting the generated verification information to the verification device. The verification device is, for example, a device configured to verify device authenticity of the information processing device using the received target verification information in response to receiving the target verification information. In this case, in a case where the target verification information and the registration verification information are the same, the verification device may determine that the device authenticity of the information processing device has been verified. In a case where the target verification information and the registration verification information are different, the verification device determines that the device authenticity of the information processing device is not verified. The device verification unit 122 receives the result of verification of the device authenticity of the information processing device from the verification device. The verification device holds registration verification information about the information processing device in advance.

The device verification unit 122 may verify the device authenticity of the information processing device by comparing the target verification information with the registration verification information. In this case, the device verification unit 122 holds the registration verification information about the information processing device in advance. The registration verification information about the information processing device may be stored in advance in a trusted platform module (TPM) of the information processing device. The information processing device is configured to include a TPM. Generally, the TPM includes a memory region having high tamper resistance. Specifically, the registration verification information about the information processing device is stored in a memory region having high tamper resistance included in the TPM. In a case where the target verification information and the registration verification information are the same, the device verification unit 122 may determine that the device authenticity of the information processing device has been verified. In a case where the target verification information and the registration verification information are different, the device verification unit 122 determines that the device authenticity of the information processing device is not verified.

The communication control device is, for example, a device (that is, the gateway) that relays communication, the device being configured to be able to dynamically change, for example, a transfer destination of data (for example, a packet). Examples of the technology that enables dynamic change of the transfer destination include a virtual private network (VPN) and software designed networking (SDN). That is, the communication control device is, for example, a VPN gateway, an SDN gateway, or the like.

The communication partner (hereinafter, it is also referred to as a communication destination of the virtual computer) of the virtual computer refers to a communication network including the network resource with which the virtual computer can perform communication.

In other words, a communication partner (that is, the communication destination of the virtual computer) of the virtual computer is a network set to be accessible by the virtual computer.

The connection destination of the virtual computer described above is a network set as a communication network including the network resource with which the virtual computer can perform communication when the user of the virtual computer is a legitimate user of the virtual computer. In other words, the connection destination of the virtual computer is a network set as a communication destination of the virtual computer when the user of the virtual computer is a legitimate user of the virtual computer. When the user of the virtual computer is a legitimate user of the virtual computer, a communication network including the network resource with which the virtual computer can perform communication is referred to as a legitimate network.

In response to an instruction from the control instruction unit 123, the communication control device switches the network that is achieved in the information processing device and that can be accessed by the virtual computer between the legitimate network and the decoy network. The virtual computer is an emulated computer. An OS program is executed on the virtual computer. A user of the virtual computer can start up an application running on the OS. The virtual computer executes an application on the OS.

As described above, the legitimate network includes a network resource that is at least any one of other information processing devices and storages that can be accessed by a legitimate user of the virtual computer, and a communication network to which the network resource is connected. The legitimate user of the virtual computer is, for example, a user (also referred to as a registered user) registered in advance as a user of the virtual computer.

A decoy network is a network that mimics the legitimate network. In the present disclosure, the decoy network is generated in such a way that the configuration of the decoy network is the same as the configuration of the legitimate network. However, the information stored in the network resource of the legitimate network is not stored in the network resource of the decoy network.

The legitimate network and the decoy network are achieved as a VPN. For example, an authentication device that authenticates a user who logs in to the virtual computer is accessed by the virtual computer as one of network resources in a network (that is, the legitimate network or the decoy network) to which the virtual computer is connected.

Setting the communication partner of the virtual computer to the decoy network means setting the communication control device to transmitting a packet from the virtual computer to the network resource of the legitimate network to the decoy network (hereinafter, referred to as decoy setting). When the setting of the communication control device is set to the decoy setting, the communication control device transfers a packet from the virtual computer to the network resource of the legitimate network toward the network resource related to the network resource. The communication control device transfers the packet from the network resource of the decoy network to the virtual computer as the packet from the network resource of the legitimate network related to the network resource.

When the communication partner of the virtual computer is the legitimate network, the communication control device transfers the packet from the virtual computer to the network resource of the legitimate network to the network resource of the legitimate network. The packet from the network resource of the legitimate network is transferred to the virtual computer as a packet from the network resource of the legitimate network. In the present disclosure, the setting in which the communication partner of the virtual computer is the legitimate network is also referred to as a legitimate setting.

### Operation

Next, the operation of the first example embodiment of the present disclosure will be described in detail with reference to the drawings.

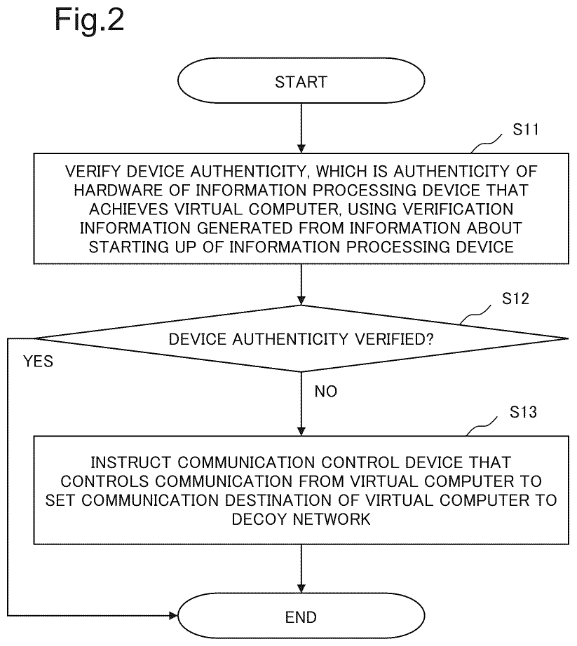

FIG. 2 is a flowchart illustrating an example of an operation of the security system according to the present disclosure.

Hereinafter, an operation of a security system 10 according to the first example embodiment of the present disclosure will be described in detail with reference to FIG. 2.

In the example illustrated in FIG. 2, first, the device verification unit 122 verifies the device authenticity, which is the authenticity of the hardware of the information processing device that achieves the virtual computer, using the verification information generated from the information about starting up of the information processing device (step S11). In a case where the device authenticity is not verified (NO in step S12), the control instruction unit 123 instructs the communication control device that controls the communication from the virtual computer to set the communication partner of the virtual computer to the decoy network (step S13). In a case where the device authenticity is verified (YES in step S12), the security system 10 ends the operation illustrated in FIG. 2.

In a case where the communication partner of the virtual computer is not determined, the control instruction unit 123 instructs the communication control device that controls the communication from the virtual computer to set the communication partner of the virtual computer to the legitimate network. When the communication partner of the virtual computer is determined to be the legitimate network, the security system 10 may perform the operation illustrated in FIG. 2.

### Effects

The present example embodiment has an effect that the attack can be guided to an environment in which the attack by the attacker can be observed while preventing the attack by the attacker.

The reason is that the device verification unit 122 verifies the device authenticity of the information processing device that achieves the virtual computer. In a case where the device authenticity is not verified, the control instruction unit 123 instructs the communication control device that controls the communication from the virtual computer to set the communication partner of the virtual computer to the decoy network. Accordingly, in a case where the device authenticity is not verified, the access from the virtual computer is limited to the decoy network. Therefore, it is possible to prevent an attacker from attacking the legitimate network. In the communication control device that controls communication from the virtual computer, an attack from the virtual computer to the decoy network can be observed. That is, the security system of the present example embodiment can guide the attack to an environment in which the attack by the attacker can be observed while preventing the attack by the attacker.

### Second Example Embodiment

Next, the second example embodiment of the present disclosure will be described in detail with reference to the drawings.

### Configuration

First, a configuration of a second example embodiment of the present disclosure will be described in detail with reference to the drawings.

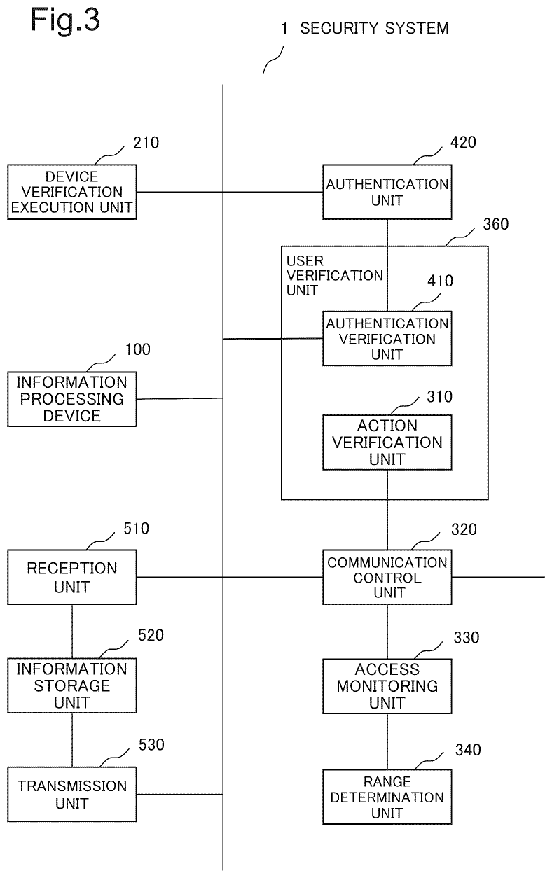

FIG. 3 is a block diagram illustrating an example of a configuration of a security system according to the present disclosure.

Hereinafter, a configuration of a security system according to a second example embodiment of the present disclosure will be described in detail with reference to FIG. 3. FIG. 3 illustrates a functional configuration of a security system 1.

In the example illustrated in FIG. 3, the security system 1 includes an information processing device 100, a device verification execution unit 210, a communication control unit 320, an access monitoring unit 330, a range determination unit 340, a user verification unit 360, an authentication unit 420, a reception unit 510, an information storage unit 520, and a transmission unit 530. The user verification unit 360 includes an action verification unit 310 and an authentication verification unit 410.

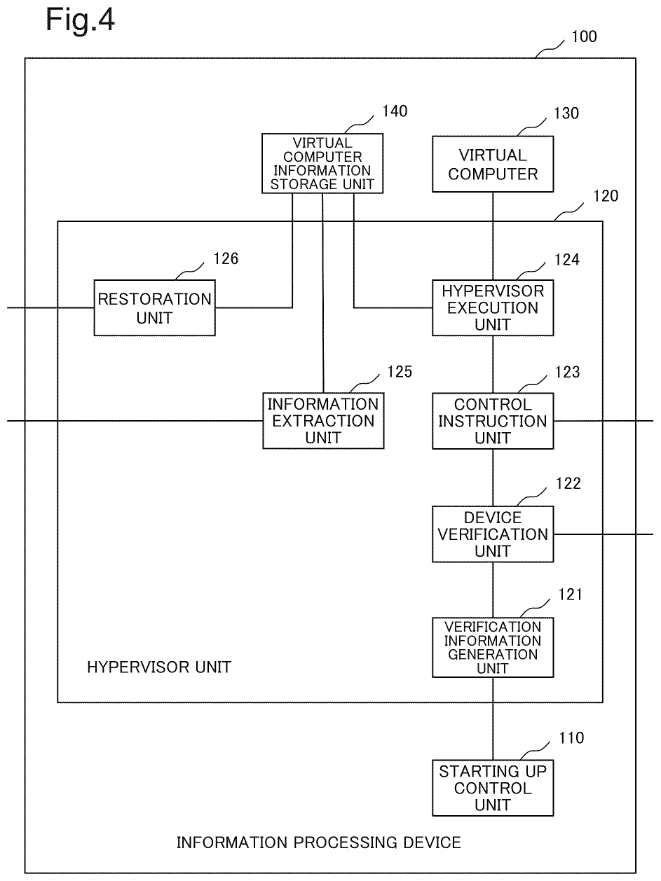

FIG. 4 is a block diagram illustrating an example of a configuration of an information processing device according to the present disclosure.

In the example illustrated in FIG. 4, the information processing device 100 includes a starting up control unit 110, a hypervisor unit 120, a virtual computer 130, and a virtual computer information storage unit 140. The hypervisor unit 120 includes a verification information generation unit 121, the device verification unit 122, the control instruction unit 123, a hypervisor execution unit 124, an information extraction unit 125, and a restoration unit 126.

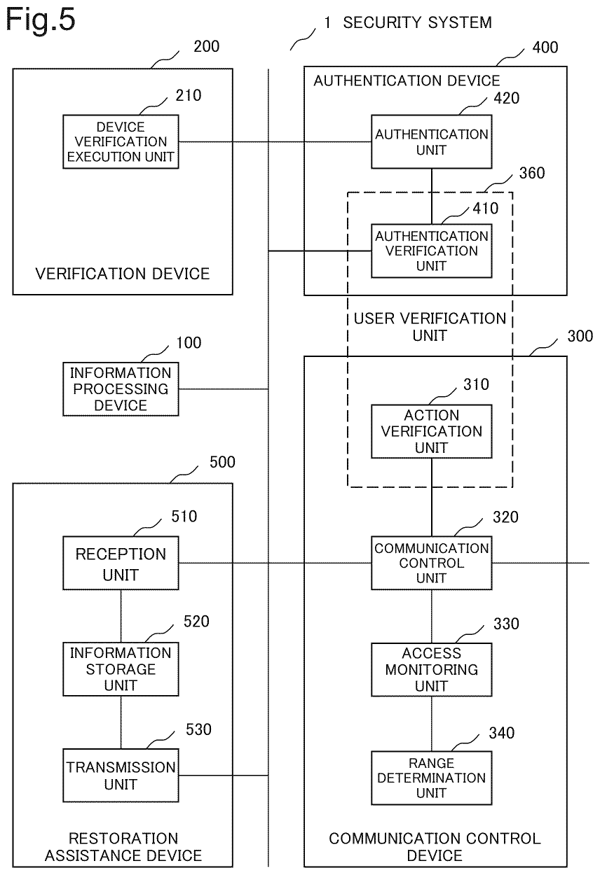

FIG. 5 is a block diagram illustrating an example of a configuration of a security system according to the present disclosure. FIG. 5 illustrates an example of a configuration in a case where security system 1 illustrated in FIG. 3 is implemented by a plurality of devices.

In the example illustrated in FIG. 5, the security system 1 includes the information processing device 100, a verification device 200, a communication control device 300, an authentication device 400, and a restoration assistance device 500.

The verification device 200 includes the device verification execution unit 210.

The communication control device 300 includes the action verification unit 310, the communication control unit 320, the access monitoring unit 330, and the range determination unit 340.

The authentication device 400 includes the authentication verification unit 410 and the authentication unit 420.

The restoration assistance device 500 includes the reception unit 510, the information storage unit 520, and the transmission unit 530.

The configuration of the device of the security system 1 is not limited to the example illustrated in FIG. 5. The security system 1 may be configured in such a way that the functions of the verification device 200, the communication control device 300, the authentication device 400, and the restoration assistance device 500 are achieved by one or more devices each including at least part of these functions. The security system 1 may be implemented by the information processing device 100 and one or more devices described above.

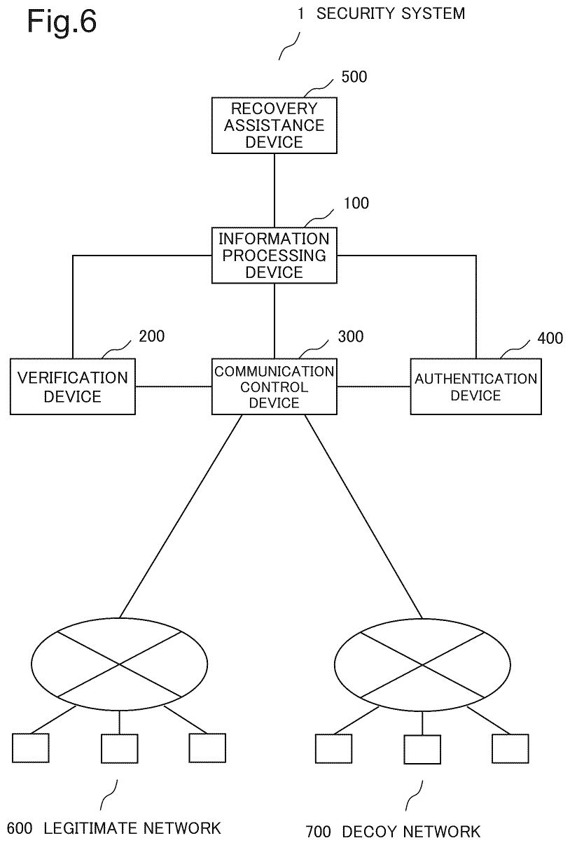

FIG. 6 is a block diagram illustrating an example of a configuration of a security system according to the present disclosure. FIG. 6 schematically illustrates an example of a configuration of the security system 1 illustrated in FIG. 5.

In the example illustrated in FIG. 6, the security system 1 includes the information processing device 100, the verification device 200, the communication control device 300, the authentication device 400, and the restoration assistance device 500. FIG. 6 further indicates that the communication control device 300 can set a communication partner of the virtual computer achieved in the information processing device 100 to a legitimate network 600 or a decoy network 700.

Next, components of the security system 1 of the present disclosure will be described in detail.

### <Information Processing Device 100>

For example, as illustrated in FIG. 4, the information processing device 100 includes the starting up control unit 110, the hypervisor unit 120, the virtual computer 130, and the virtual computer information storage unit 140. The hypervisor unit 120 includes a verification information generation unit 121, the device verification unit 122, the control instruction unit 123, a hypervisor execution unit 124, an information extraction unit 125, and a restoration unit 126.

### <Starting Up Control Unit 110>

The starting up control unit 110 executes processing at the time of starting up of the information processing device 100 in response to the power-on of the information processing device 100 and the reset of the information processing device 100. The starting up control unit 110 is, for example, a boot loader of the information processing device 100 and firmware such as a unified extensible firmware interface (UEFI) or a BIOS.

### <Verification Information Generation Unit 121>

The verification information generation unit 121 generates the above-described verification information from information about starting up of the information processing device obtained at the time of starting up of the information processing device. The verification information generation unit 121 acquires information about starting up of the information processing device to generate the above-described verification information from the acquired information about starting up of the information processing device. The verification information generation unit 121 may be achieved by, for example, a TPM.

### <Device Verification Unit 122>

The device verification unit 122 verifies the device authenticity, which is the authenticity of the hardware of the information processing device 100 that achieves the virtual computer 130, using the verification information generated from the information about starting up of the information processing device 100. The device verification unit 122 is the same as the device verification unit 122 of the first example embodiment.

For example, the device verification unit 122 may verify the device authenticity of the information processing device 100 by transmitting the generated verification information to the verification device 200. The verification device 200 is related to the verification device of the first example embodiment. The verification device 200 is, for example, a device configured to verify the device authenticity of the information processing device 100 using the received target verification information in response to receiving the target verification information. In this case, in a case where the target verification information and the registration verification information are the same, the verification device 200 (specifically, as described later, the device verification execution unit 210) may determine that the device authenticity of the information processing device 100 has been verified. In a case where the target verification information and the registration verification information are different, the verification device 200 determines that the device authenticity of the information processing device 100 is not verified. The device verification unit 122 receives the result of verification of the device authenticity of the information processing device 100 from the verification device 200. The verification device 200 holds the registration verification information about the information processing device 100 in advance.

The device verification unit 122 may verify the device authenticity of the information processing device 100 by comparing the target verification information with the registration verification information. In this case, the device verification unit 122 holds the registration verification information about the information processing device 100 in advance. The registration verification information about the information processing device 100 may be stored in advance in the TPM of the information processing device 100. The information processing device 100 is configured to include a TPM. In a case where the target verification information and the registration verification information are the same, the device verification unit 122 may determine that the device authenticity of the information processing device 100 has been verified. In a case where the target verification information and the registration verification information are different, the device verification unit 122 determines that the device authenticity of the information processing device 100 is not verified.

In the following description, the device verification unit 122 verifies the device authenticity of the information processing device 100, for example, by transmitting the generated verification information to the verification device 200.

### <Control Instruction Unit 123>

In a case where the device authenticity is not verified, the control instruction unit 123 instructs the communication control device 300 that controls communication from the virtual computer to set the decoy network 700 as a communication partner of the virtual computer. The control instruction unit 123 is the same as the control instruction unit 123 of the first example embodiment. The communication control device 300 is related to the communication control device of the first example embodiment. In a case where the device authenticity is verified, the control instruction unit 123 instructs the communication control device 300 that controls communication from the virtual computer to set the communication partner of the virtual computer to the legitimate network 600. The legitimate network 600 is related to the legitimate network of the first example embodiment. The decoy network 700 is related to the decoy network 700 of the first example embodiment.

For example, by transmitting a decoy setting instruction to the communication control device 300, the control instruction unit 123 instructs the communication control device 300 to set the decoy network 700 as a communication partner of the virtual computer. The decoy setting instruction is an instruction to set a communication partner of the virtual computer in the decoy network 700. For example, the control instruction unit 123 transmits a legitimate setting instruction to the communication control device 300 to instruct the communication control device 300 to set the communication partner of the virtual computer to the legitimate network 600. The legitimate setting instruction is an instruction to set a communication partner of the virtual computer in the legitimate network 600.

In response to an instruction from the control instruction unit 123, the communication control device 300 switches the network that is achieved in the information processing device 100 and that can be accessed by the virtual computer between the legitimate network 600 and the decoy network 700. For example, in response to receiving the decoy setting instruction, the communication control device 300 sets, as the decoy network 700, a network that can be accessed by the virtual computer achieved in the information processing device 100. For example, in response to receiving the legitimate setting instruction, the communication control device 300 sets, as the legitimate network 600, a network that can be accessed by the virtual computer achieved in the information processing device 100.

### <Virtual Computer Information Storage Unit 140>

The virtual computer information storage unit 140 stores information (denoted as virtual computer information) used to achieve the virtual computer 130. The virtual computer information includes the information about the OS of the virtual computer 130. The virtual computer information may include the application information that operates on the OS of the virtual computer 130.

### <Hypervisor Execution Unit 124>

After the control instruction unit 123 transmits the decoy setting instruction or the legitimate setting instruction, the hypervisor execution unit 124 executes a process of achieving the virtual computer 130 on the information processing device 100 using the virtual computer information. The method of achieving the virtual computer 130 on the information processing device 100 is one of various existing methods for achieving the virtual computer.

### <Virtual Computer 130>

The virtual computer 130 is a virtual computer that operates on the information processing device 100. The virtual computer 130 operates as a computer in which the OS is installed. The virtual computer 130 provides the user with the function of the computer in which the OS is installed.

The virtual computer 130 can access the network resource of a network (the legitimate network 600 or the decoy network 700) set as a communication destination of the virtual computer 130 by the communication control device 300. As described above, decoy network 700 mimics the legitimate network 600. The configuration of the legitimate network 600 is the same as the configuration of the decoy network 700. The communication control device 300 sets a network of a communication destination of the virtual computer 130 regardless of the virtual computer 130.

The user of the virtual computer 130 accesses the virtual computer 130 from a terminal device different from the information processing device 100. Specifically, for example, the user of the virtual computer 130 logs in the virtual computer 130. When the authentication associated with the login is successful, the user of the virtual computer 130 can use the virtual computer 130. After the authentication associated with the login is successful, the user of the virtual computer 130 can access the network resource of the network of the communication destination of the virtual computer 130 via the virtual computer 130. Access from the virtual computer 130 to the network resource of the communication destination network of the virtual computer 130 is performed via the communication control unit 320 of the communication control device 300. A packet of communication between the virtual computer 130 and the network resource of the communication destination network of the virtual computer 130 is relayed by the communication control unit 320 of the communication control device 300.

### <Information Extraction Unit 125>

The information extraction unit 125 extracts the information about the OS of the virtual computer 130 from the virtual computer information stored in the virtual computer information storage unit 140. The information about the OS of the virtual computer 130 is information necessary for restoring the OS of the virtual computer 130. The information extraction unit 125 may extract the application information operating on the OS (that is, information necessary for storing the application) in addition to the information about the OS of the virtual computer 130.

The information extraction unit 125 transmits the extracted OS information to the restoration assistance device 500. When extracting the application information, the information extraction unit 125 transmits the extracted OS information and the application information to the restoration assistance device 500.

The restoration assistance device 500 stores the OS information and the application information received from the information extraction unit 125 in the information storage unit 520. In a case where the restoration assistance device 500 has not received the application information, the application information may not be stored in the information storage unit 520.

The information extraction unit 125 extracts the OS information from the virtual computer information stored in the virtual computer information storage unit 140 at a timing when it is determined that the attack on the information processing device 100 has not been made yet. In a case where the application information is extracted, the information extraction unit 125 extracts the OS information and the application information from the virtual computer information stored in the virtual computer information storage unit 140 in a case where the application information is extracted at a timing when it is determined that the attack on the information processing device 100 has not been made yet. The timing at which it is determined that the attack on the information processing device 100 has not been made yet is, for example, a timing at which the power of the information processing device 100 is first turned on. The timing at which it is determined that the attack on the information processing device 100 has not been made may be, for example, a timing immediately after the OS is updated (for example, version upgrade, security update, or the like) after the OS is restored. The timing at which it is determined that the attack on the information processing device 100 has not been made may be, for example, a timing immediately after the OS and the application are updated after the OS and the application are restored.

In the following description, the OS information includes the application information when the application is recovered in addition to the OS. When the OS information includes the application information, recovery of the OS may indicate recovery of the OS and the application.

### <Restoration Unit 126>

For example, in response to receiving a restoration instruction that is an instruction to restore the OS of the virtual computer 130 of the information processing device 100, the restoration unit 126 reads the information about the OS of the virtual computer 130 of the information processing device 100 from the information storage unit 520 of the restoration assistance device 500. For example, the restoration instruction may be input via an input device of the information processing device 100 and delivered to the restoration unit 126. The restoration unit 126 restores the OS of the virtual computer 130 using the OS information read from the information storage unit 520 of the restoration assistance device 500. The restoration unit 126 restores the OS information in the virtual computer information stored in the virtual computer information storage unit 140 using, for example, the OS information read from the information storage unit 520 of the restoration assistance device 500.

Specifically, the restoration unit 126 may transmit an instruction to transmit the OS information to the restoration assistance device 500 in response to receiving the restoration instruction. In response to receiving the instruction to transmit the information about the OS, the restoration assistance device 500 reads the information about the OS of the virtual computer 130 of the information processing device 100 from the information storage unit 520. The restoration assistance device 500 transmits the read information about the OS of the virtual computer 130 of the information processing device 100 to the restoration unit 126.

The restoration unit 126 receives, from the restoration assistance device 500, the information about the OS of the virtual computer 130 of the information processing device 100, the information being read from the information storage unit 520 of the restoration assistance device 500. The restoration unit 126 restores the information about the OS in the virtual computer information stored in the virtual computer information storage unit 140 using the received information about the OS of the virtual computer 130 of the information processing device 100.

### <Verification Device 200>

As described above, the verification device 200 includes the device verification execution unit 210.

### <Device Verification Execution Unit 210>

The device verification execution unit 210 receives the verification information generated from the information about starting up of the information processing device 100 from the device verification unit 122 of the information processing device 100. Upon receiving the verification information about the information processing device 100, the device verification execution unit 210 compares the target verification information, which is the received verification information, with the registration verification information to verify the device authenticity, which is the authenticity of the hardware of the information processing device 100. As described above, the registration verification information is verification information generated from the information about starting up of the information processing device 100 in a case where the information processing device 100 is normal. The device verification execution unit 210 holds the registration verification information about the information processing device 100 in advance. In a case where the target verification information and the registration verification information are the same, the device verification execution unit 210 may determine that the device authenticity of the information processing device 100 has been verified. In a case where the target verification information and the registration verification information are different, the device verification execution unit 210 determines that the device authenticity of the information processing device 100 is not verified.

The device verification execution unit 210 transmits the result of the verification of the device authenticity of the information processing device 100 to the device verification unit 122 of the information processing device 100.

### <User Verification Unit 360>

The user verification unit 360 verifies, from the action of the user of the virtual computer, the user authenticity, which is the authenticity of the user. In the example illustrated in FIG. 5, the user verification unit 360 includes the action verification unit 310 included in the communication control device 300 and the authentication verification unit 410 included in the authentication device. The user verification unit 360 verifies, from the action of the user of the virtual computer, the user authenticity, which is the authenticity of the user, by at least any one of the action verification unit 310 and the authentication verification unit 410. The action verification unit 310 and the authentication verification unit 410 will be described in detail later.

### <Authentication Device 400>

As described above, the authentication device 400 includes the authentication verification unit 410 and the authentication unit 420.

### <Authentication Unit 420>

The authentication unit 420 authenticates the user of the virtual computer 130.

Specifically, for example, the virtual computer 130 transmits, to the authentication unit 420, authentication data including, for example, a user identification (ID) and data (for example, a password or the like) for proving that the user of the virtual computer 130 is a user indicated by the user ID. The authentication unit 420 receives authentication data from the virtual computer 130.

The authentication unit 420 determines whether the user of the virtual computer 130 is the user indicated by the user ID using the authentication data. When determining that the user of the virtual computer 130 is the user indicated by the user ID using the authentication data, the authentication unit 420 determines that the authentication of the user of the virtual computer 130 is successful. When determining that the user of the virtual computer 130 is not the user indicated by the user ID using the authentication data, the authentication unit 420 determines that the authentication of the user of the virtual computer 130 has failed.

The authentication method is not limited to the method using the above-described password. The authentication method may be another authentication method. For example, the authentication method may be two-factor authentication by any two-factor authentication method. The authentication method may be multi-factor authentication by any multi-factor authentication method. This multi-factor authentication is authentication by three or more factors. The authentication method may be biometric authentication using biometric data that is at least any one of a face image, an iris image, a fingerprint image, and the like. The authentication method may be authentication using a personal certificate or the like.

The authentication unit 420 transmits the result of the authentication to the virtual computer 130. The result of the authentication transmitted to the virtual computer 130 may be information indicating whether the authentication has succeeded.

The authentication unit 420 further transmits information about the result of the authentication to the authentication verification unit 410. The authentication result information transmitted to the authentication verification unit 410 is, for example, information identifying the virtual computer 130, the user ID of the user who has performed the authentication, and information indicating whether the authentication has succeeded.

### <Authentication Verification Unit 410>

The authentication verification unit 410 receives information about the result of the authentication from the authentication unit 420. The authentication verification unit 410 verifies the user authenticity of the user using the result of authentication of the user indicated by the information about the result of authentication.

Specifically, in a case where authentication of the user of the virtual computer 130 has failed continuously for a predetermined number of times or more, the authentication verification unit 410 determines that the user authenticity, which is the authenticity of the user, is not verified. The authenticity of the user is that the user is a legitimate user of the virtual computer 130. The absence of authenticity of the user indicates that the user is not a legitimate user of the virtual computer 130. The user authenticity being verified indicates that the user is determined to be a legitimate user of the virtual computer 130. That the user authenticity is not verified indicates that the user is determined not to be a legitimate user of the virtual computer 130.

In a case where the user of the virtual computer 130 who is not the registered user registered as the user of the virtual computer 130 succeeds in authentication, the authentication verification unit 410 determines that the user authenticity is not verified. The authentication verification unit 410 holds information about the registered user of the virtual computer 130 in advance.

In a case where the user of the virtual computer 130, who is a registered user registered as the user of the virtual computer 130, succeeds in authentication without failing in authentication continuously for a predetermined number of times or more, the authentication verification unit 410 determines that the user authenticity is verified. The user of the virtual computer 130 refers to a person (in this case, a person who is performing an operation for authentication for logging in to the virtual computer 130) operating the virtual computer 130.

In a case where the user authenticity of the user of the virtual computer 130 is not verified, in other words, in a case where it is determined that the user authenticity of the user of the virtual computer 130 is not verified, the authentication verification unit 410 transmits a decoy setting instruction to the communication control unit 320 of the communication control device 300.

### <Communication Control Device 300>

The communication control device 300 includes the action verification unit 310, the communication control unit 320, the access monitoring unit 330, and the range determination unit 340.

### <Communication Control Unit 320>

The communication control unit 320 relays communication between the virtual computer 130 and a network (specifically, for example, a network resource of a network set as a communication destination of the virtual computer) set as a communication destination of the virtual computer.

In response to an instruction from the control instruction unit 123, the communication control unit 320 switches the network that is achieved in the information processing device 100 and that can be accessed by the virtual computer 130 between the legitimate network 600 and the decoy network 700. For example, in response to receiving the decoy setting instruction, the communication control unit 320 sets, as the decoy network 700, a network that can be accessed by the virtual computer 130 achieved in the information processing device 100. For example, in response to receiving the legitimate setting instruction, the communication control unit 320 sets, as the legitimate network 600, a network that can be accessed by the virtual computer 130 achieved in the information processing device 100. For example, in a case where the decoy setting instruction has not been received, the communication control unit 320 may set, as the legitimate network 600, a network that can be accessed by the virtual computer 130 achieved in the information processing device 100. In other words, for example, when the information processing device 100 is started up, the communication control unit 320 may set, as the legitimate network 600, a network that can be accessed by the virtual computer 130 achieved in the information processing device 100. Until receiving the decoy setting instruction from the information processing device 100, the communication control unit 320 may maintain a state in which the network that can be accessed by the virtual computer 130 achieved in the information processing device 100 is the legitimate network 600.

### <Access Monitoring Unit 330>

The access monitoring unit 330 monitors access from the virtual computer 130 to a network set as a communication destination of the virtual computer 130. That is, the access monitoring unit 330 maintains packets of communication between the virtual computer 130 and a network (specifically, for example, a network resource of the network) that is a communication destination of the virtual computer 130. In other words, the access monitoring unit 330 captures and stores such a packet.

The access monitoring unit 330 further estimates an access action which is an action of the virtual computer 130 to access the network resource of the network which is the communication destination of the virtual computer 130 from the information about the captured packet. The access action may be represented by an access destination and content of the access (in other words, the type of access). The type of access is, for example, reading, writing, rewriting, erasing, or the like. The type of access is not limited to these examples. For example, the access monitoring unit 330 estimates an access destination from information of a header of a packet. The access monitoring unit 330 may reconstruct data transmitted by the packet from the captured one or more packets. The access monitoring unit 330 may determine the content of the access using the reconfigured data.

In a case where the network of the communication destination of the virtual computer 130 is not the decoy network 700 and the authenticity of the user of the virtual computer 130 is verified, the access monitoring unit 330 may estimate the access action from the stored packet and then discard the packet.

The access monitoring unit 330 stores the packet while the communication destination network of the virtual computer 130 is set in the decoy network 700 without discarding the packet. In a case where the authenticity of the user of the virtual computer 130 is not verified, the access monitoring unit 330 stores the packet of the communication between the virtual computer 130 and the network of the communication destination of the virtual computer while the user uses the virtual computer 130, without discarding the packet.

### <Range Determination Unit 340>

The range determination unit 340 determines an access action range, which is a range of an access action of the virtual computer 130 used by the registered user, from a past access action (that is, the access action determined from the stored packet) of the virtual computer 130 while the registered user is using. As described above, the registered user is a user registered as a user of the virtual computer 130.

For example, the range determination unit 340 may determine a network resource accessed from the virtual computer 130 for each type of access action while the registered user is using the network resource as the access action range. The range determination unit 340 may determine, for example, a network resource in which the frequency of access from the virtual computer 130 is equal to or higher than a predetermined frequency for each type of access action while the registered user is using the network resource as the access action range. The frequency of access may be, for example, the number of times of access per unit time.

### <Action Verification Unit 310>

The action verification unit 310 verifies the authenticity of the user of the virtual computer 130 using information about an access action that is an action of the user of the virtual computer 130 to access the resource of the network (that is, a network resource).

In a case where the access action of the user of the virtual computer 130 does not satisfy the predetermined action criterion, the action verification unit 310 determines that user authenticity of the user is not verified. The predetermined action criterion includes, for example, not performing an access action other than a predetermined access action. The predetermined action criterion may include, for example, not accessing a network resource that is not a predetermined network resource (for example, a network resource to which access is allowed). The predetermined action criterion is not limited to these examples. The action verification unit 310 determines that the user authenticity of the user has been verified while the access action of the user of the virtual computer 130 satisfies a predetermined action criterion.

In a case where the access action of the virtual computer 130 is out of the above-described access action range, the action verification unit 310 determines that the user authenticity of the user of the virtual computer 130 is not verified. As described above, the access action range is a range of access action determined from past access action of the virtual computer 130 during use by a registered user registered as a user of the virtual computer 130.

When the difference between the frequency of the access action of the virtual computer 130 and the frequency of the access action of the type same as the type of the access action in the access action range satisfies the criterion, the action verification unit 310 determines that the access action of the virtual computer 130 is included in the access action range. In a case where the difference between the frequency of the access action of the virtual computer 130 and the frequency in the access action range of the access action of the type same as the type of the access action does not satisfy the criterion, the action verification unit 310 determines that the access action of the virtual computer 130 is out of the access action range (that is, it is not included in the access action range). This criterion is larger than a threshold value of the access action of the type same as the type of the access action of the virtual computer 130, the threshold value being determined from the frequency in the access action range. The threshold value may be a value obtained by multiplying the frequency of the access action of the type same as the type of the access action of the virtual computer 130 in the access action range by a predetermined positive number. The threshold value may be a value obtained by adding a predetermined positive number to the frequency of the access action of the type same as the type of the access action of the virtual computer 130 in the access action range.

The action verification unit 310 determines that the user authenticity of the user has been verified while the access action of the virtual computer 130 is not out of the access action range and the access action of the virtual computer 130 satisfies the predetermined action criterion. In a case where the access action of the virtual computer 130 is out of the access action range and in a case where the access action of the virtual computer 130 does not satisfy the predetermined action criterion, the action verification unit 310 determines that the user authenticity is not verified regardless of whether the user of the virtual computer 130 is a registered user. In this case, the legitimate user of the virtual computer 130 is, for example, a user who uses the virtual computer 130 in such a way that the access action of the virtual computer 130 is not out of the access action range and satisfies a predetermined action criterion.

In a case where the action verification unit 310 determines that the user authenticity of the user of the virtual computer 130 is not verified, the communication control unit 320 sets, in the decoy network 700, a network (that is, the network of the communication destination of the virtual computer 130) that is achieved in the information processing device 100 and that can be accessed by the virtual computer 130.

In a case where it is determined that the user authenticity of the user of the virtual computer 130 is not verified, the action verification unit 310 may transmit a decoy setting instruction to the communication control unit 320. In response to receiving the decoy setting instruction, the communication control unit 320 sets a network (that is, the network of the communication destination of the virtual computer 130) accessible by the virtual computer 130 in the decoy network 700.

### <Restoration Assistance Device 500>

As described above, the restoration assistance device 500 includes the reception unit 510, the information storage unit 520, and the transmission unit 530.

### <Reception Unit 510>

The reception unit 510 receives the extracted information about the OS of the virtual computer 130 from the information extraction unit 125 of the information processing device 100. The reception unit 510 stores the received information about the OS of the virtual computer 130 in the information storage unit 520. As described above, the OS information may include the application information.

### <Information Storage Unit 520>

The information storage unit 520 stores the OS information received from the information extraction unit 125 of the information processing device 100.

### <Transmission Unit 530>

In response to receiving the instruction to transmit the information about the OS from the restoration unit 126 of the information processing device 100, the transmission unit 530 reads the information about the OS of the information processing device 100 from the information storage unit 520. The transmission unit 530 transmits the information about the OS of the information processing device 100, the information being read from the information storage unit 520, to the restoration unit 126 of the information processing device 100.

### Operation

Next, an operation of the second example embodiment of the present disclosure will be described in detail with reference to the drawings.

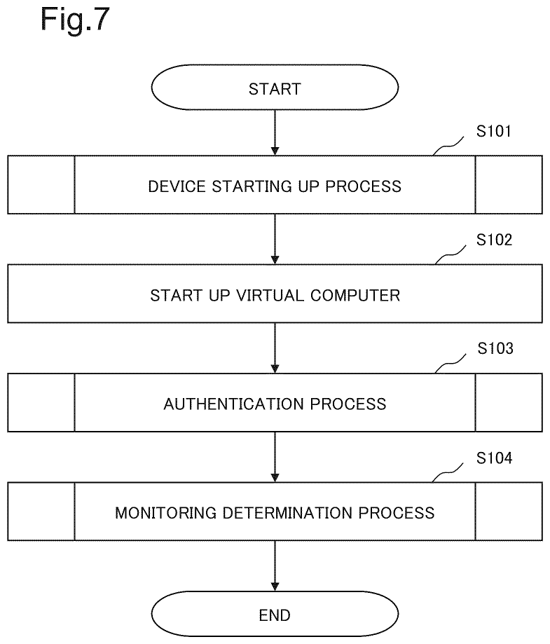

FIG. 7 is a flowchart illustrating an example of the operation of the security system according to the present disclosure.

Hereinafter, an operation of the security system 1 according to the second example embodiment of the present disclosure will be described in detail with reference to FIG. 7.

For example, in a case where the power of the information processing device 100 is turned on and in a case where the information processing device 100 is restarted, the security system 1 starts the operation illustrated in FIG. 7.

In the example illustrated in FIG. 7, the security system 1 performs a device starting up process (step S101). The device starting up process will be described in detail later. Next, the hypervisor execution unit 124 of the information processing device 100 starts up the virtual computer 130 (step S102).

After the virtual computer 130 is started up, the security system 1 may pause the operation of FIG. 7 until the user of the virtual computer 130 is authenticated. When the user of the virtual computer 130 starts authentication, the security system 1 performs the operations in and after step S103.

In step S103, the security system 1 performs an authentication process (step S103). The authentication process will be described in detail later. The security system 1 performs a monitoring determination process (step S104). The monitoring determination process will be described in detail later.

When the user logs out of the virtual computer 130 after the authentication process is executed, the security system 1 may continue the monitoring determination process. When the user starts authentication for logging in to the virtual computer 130 while the security system 1 continues the monitoring determination process, the security system 1 may perform the operations in and after step S103.

After the power of the information processing device 100 is turned off, in a case where the power of the information processing device 100 is turned on and in a case where the information processing device 100 is restarted, the security system 1 starts the operation from step S101 again.

Next, the operation of the device starting up process will be described.

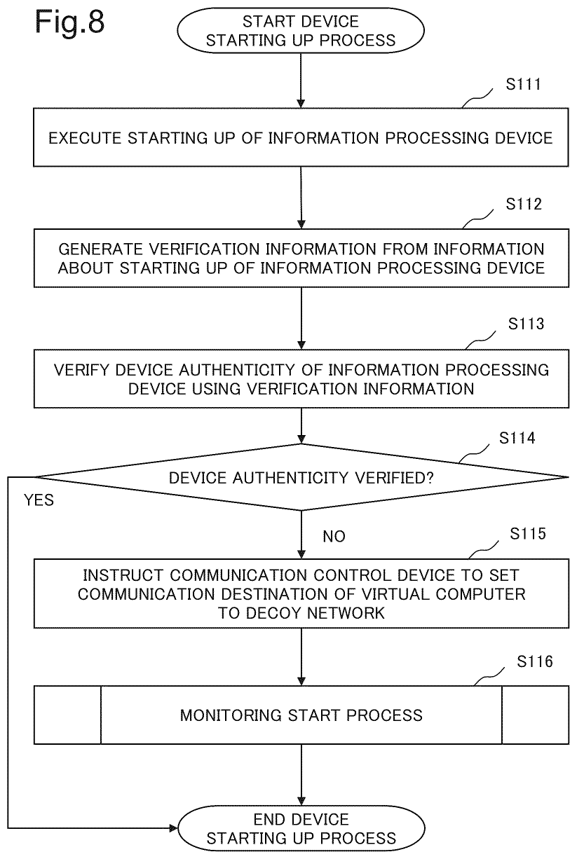

FIG. 8 is a flowchart illustrating an example of the operation of the device starting up process of the security system according to the present disclosure.

Hereinafter, the operation of the device starting up process of the security system 1 according to the second example embodiment of the present disclosure will be described in detail with reference to FIG. 8.

In a case where the power of the information processing device 100 is turned on and in a case where the information processing device 100 is restarted, the security system 1 starts the device starting up process illustrated in FIG. 7, that is, the operation illustrated in FIG. 8.

In the example illustrated in FIG. 8, first, the starting up control unit 110 executes starting up of the information processing device (step S111). That is, the starting up control unit 110 executes processing at the time of starting up of the information processing device 100. Next, the verification information generation unit 121 generates the verification information from the information about starting up of the information processing device 100 (step S112).

Next, the device verification unit 122 verifies the device authenticity of the information processing device 100 using the verification information (step S113). As described above, the device verification unit 122 may perform the device authenticity of the information processing device 100 by transmitting the verification information to the verification device 200. The device verification unit 122 may receive the verification result from the verification device 200. In a case where the device authenticity is verified (YES in step S114), the security system 1 ends the operation illustrated in FIG. 8.

In a case where the device authenticity is not verified (NO in step S114), the control instruction unit 123 instructs the communication control device 300 to set the communication partner of the virtual computer 130 to the decoy network (step S115). The security system 1 executes a monitoring start process (step S116). The monitoring start process will be described in detail below. The security system 1 ends the operation illustrated in FIG. 8.

Next, the operation of the monitoring start process will be described.

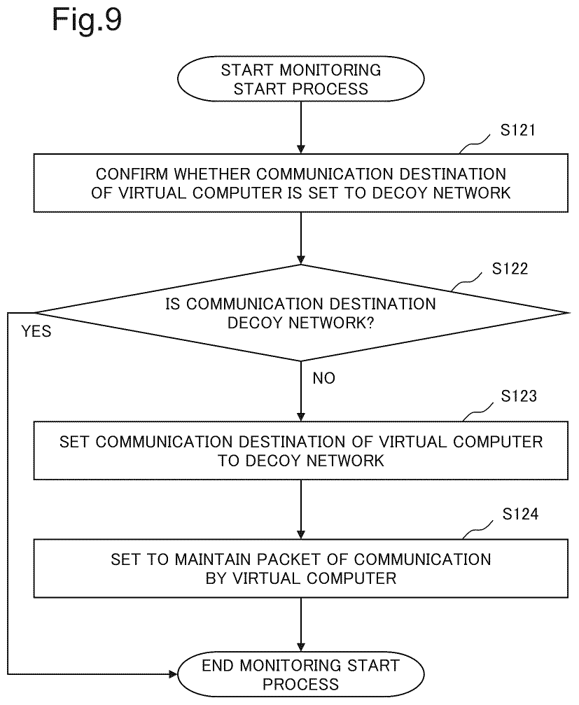

FIG. 9 is a flowchart illustrating an example of an operation of the monitoring start process of the security system according to the present disclosure.

Hereinafter, an operation of the monitoring start process of the security system 1 according to the second example embodiment of the present disclosure will be described in detail with reference to FIG. 9.

In the example illustrated in FIG. 9, first, the communication control unit 320 of the communication control device 300 checks whether the communication destination of the virtual computer 130 is set to the decoy network 700 (step S121). When the communication destination is the decoy network (YES in step S122), the security system ends the operation illustrated in FIG. 9.

When the communication destination is not the decoy network (NO in step S122), the communication control unit 320 sets the communication destination of the virtual computer 130 to the decoy network 700 (step S123). The communication control unit 320 performs setting so that the access monitoring unit 330 maintains the packet of communication by the virtual computer 130 (step S124).

The access monitoring unit 330 stores the packet of communication by the virtual computer 130. However, in a case where the access monitoring unit 330 is not set to maintain the packet of the communication by the virtual computer 130, the access monitoring unit 330 discards the packet after estimating the access action from the stored packet. In a case where the access monitoring unit 330 is set to maintain a packet of communication by the virtual computer 130, the access monitoring unit 330 does not discard the packet after estimating the access action from the stored packet.

Next, an operation of the authentication process will be described.

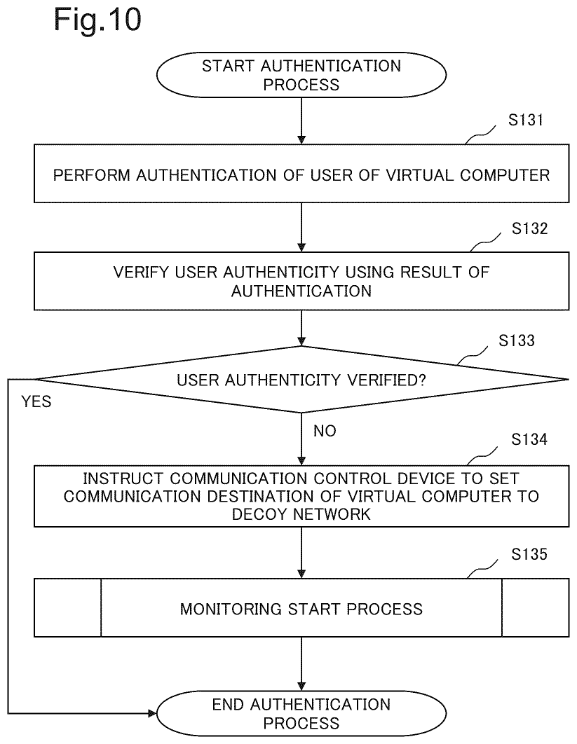

FIG. 10 is a flowchart illustrating an example of the operation of the authentication process of the security system according to the present disclosure.

Hereinafter, an operation of the authentication process of the security system 1 according to the second example embodiment of the present disclosure will be described in detail with reference to FIG. 10.

In the example illustrated in FIG. 10, first, the authentication unit 420 of the authentication device 400 authenticates the user of the virtual computer 130 (step S131). Next, the authentication verification unit 410 verifies the user authenticity using the result of the authentication (step S132). In step S132, the authentication verification unit 410 verifies the user authenticity of the user of the virtual computer 130. In a case where the user authenticity is verified (YES in step S133), the security system 1 ends the operation illustrated in FIG. 10.

In a case where the user authenticity is not verified (NO in step S133), the authentication verification unit 410 instructs the communication control device 300 to set the communication destination of the virtual computer 130 to the decoy network (step S134). Next, the security system 1 executes the monitoring start process (step S135). The security system 1 ends the operation illustrated in FIG. 10.

Next, an operation of the monitoring determination process will be described.

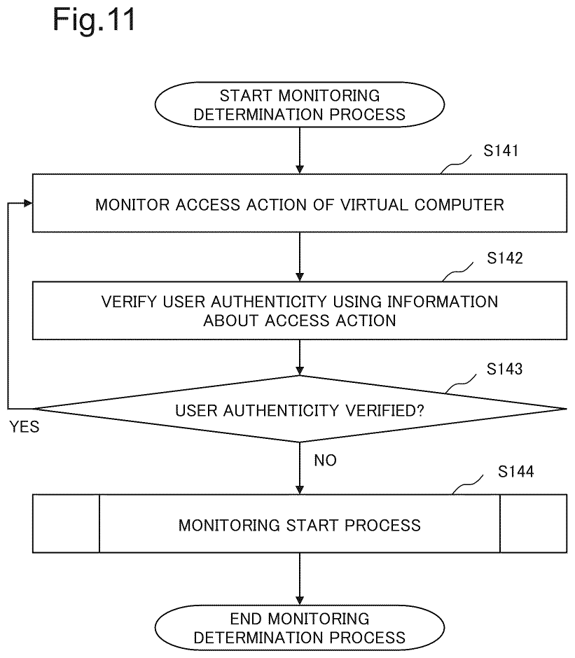

FIG. 11 is a flowchart illustrating an example of an operation of the monitoring determination process of the security system according to the present disclosure.

Hereinafter, an operation of the monitoring determination process of the security system 1 according to the second example embodiment of the present disclosure will be described in detail with reference to FIG. 11.

In the example illustrated in FIG. 11, the access monitoring unit 330 monitors the access action of the virtual computer 130 (step S141). The action verification unit 310 verifies the user authenticity using the information about the access action (step S142). In a case where the user authenticity is verified (YES in step S143), the security system 1 repeats the operations in and after step S141.

In a case where the user authenticity is not verified (NO in step S143), the security system 1 executes the monitoring start process (step S144). The security system 1 ends the operation illustrated in FIG. 11.

Next, the operation of the process of storing the information about the OS (that is, processing of storing the information about the OS of the virtual computer 130) will be described.

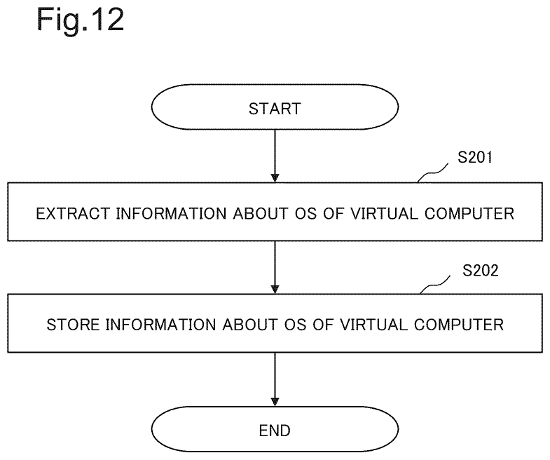

FIG. 12 is a flowchart illustrating an example of an operation of a process of storing the OS information in the security system according to the present disclosure.

Hereinafter, an operation of a process of storing the OS information in the security system 1 according to the second example embodiment of the present disclosure will be described in detail with reference to FIG. 12.

In the example illustrated in FIG. 12, first, the information extraction unit 125 extracts the information about the OS of the virtual computer 130 (step S201). The information extraction unit 125 transmits the extracted OS information to the reception unit 510 of the restoration assistance device 500.

Next, the reception unit 510 stores the information about the OS of the virtual computer 130 in the information storage unit 520. That is, the information storage unit 520 stores the information about the OS of the virtual computer 130 (step S202). The security system 1 ends the operation illustrated in FIG. 12.

Next, the operation of the process of restoring the information about the OS (that is, processing of restoring the information about the OS of the virtual computer 130) will be described.

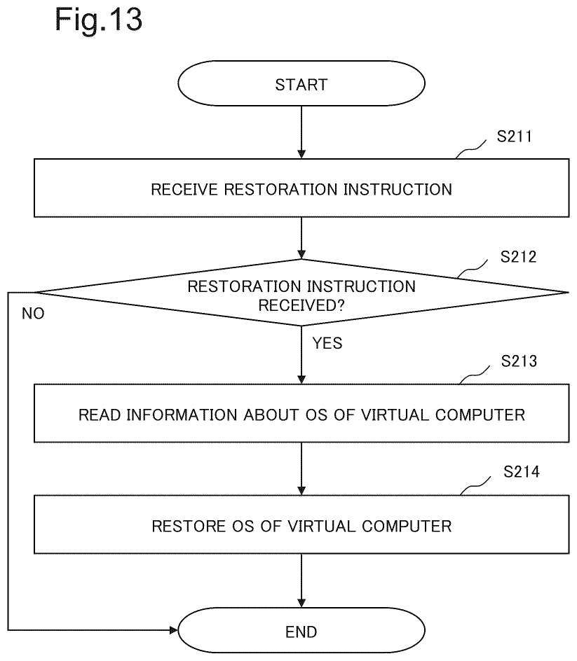

FIG. 13 is a flowchart illustrating an example of an operation of a process of restoring the OS information in the security system according to the present disclosure.

Hereinafter, an operation of a process of restoring the OS information in the security system 1 according to the second example embodiment of the present disclosure will be described in detail with reference to FIG. 13.

In the example illustrated in FIG. 13, the restoration unit 126 receives a restoration instruction (step S211). When the restoration instruction is not received (NO in step S212), the security system 1 ends the operation illustrated in FIG. 13.

When the restoration instruction is received (YES in step S212), the restoration unit 126 reads the information about the OS of the virtual computer (step S213). Specifically, the restoration unit 126 transmits an instruction to transmit the OS information to the transmission unit 530 of the restoration assistance device 500. Upon receiving the instruction to transmit the information about the OS, the transmission unit 530 reads the information about the OS of the virtual computer 130 from the information storage unit 520. The transmission unit 530 transmits the read information about the OS of the virtual computer 130 to the restoration unit 126. The restoration unit 126 receives the information about the OS of the virtual computer 130 from the transmission unit 530.

Next, the restoration unit 126 restores the OS of the virtual computer 130 using the received information about the OS of the virtual computer 130.

### Effects

The present example embodiment described above has the same effect as the first example embodiment. The reason is the same as the reason why the effect of the first example embodiment occurs.

### First Modification of Second Example Embodiment

The security system of FIG. 3 may be achieved by a device having a configuration different from that of the example illustrated in FIG. 5.

As described above, the security system 1 may be configured in such a way that the functions of the verification device 200, the communication control device 300, the authentication device 400, and the restoration assistance device 500 are achieved by one or more devices each including at least part of these functions. The security system 1 may be implemented by the information processing device 100 and one or more devices described above. For example, in FIG. 3, all the units other than the information processing device 100 may be mounted on the same device (for example, denoted as a security device). For example, the access monitoring unit 330 may be included in a device (for example, denoted as an access monitoring device) different from a device (for example, a communication control device) including the communication control unit 320.

Hereinafter, an example in which the configuration of the device is different from the example described in the second example embodiment will be specifically described.

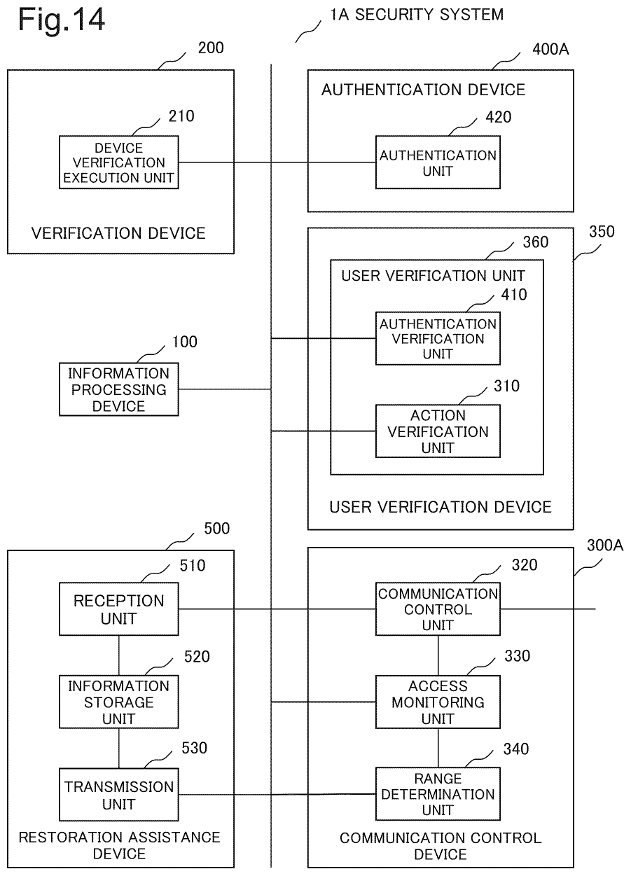

FIG. 14 is a block diagram illustrating an example of a configuration of a security system according to the present disclosure.

Hereinafter, a configuration of a security system according to a modification of the second example embodiment will be described in detail with reference to FIG. 14.

In the example illustrated in FIG. 14, a security system 1A includes the information processing device 100, the verification device 200, a communication control device 300A, a user verification device 350, an authentication device 400A, and the restoration assistance device 500. The information processing device 100, the verification device 200, and the restoration assistance device 500 are the same as the information processing device 100, the verification device 200, and the restoration assistance device 500 of the second example embodiment, respectively.

The communication control device 300A includes the communication control unit 320, the access monitoring unit 330, and the range determination unit 340. The communication control unit 320, the access monitoring unit 330, and the range determination unit 340 are the same as the communication control unit 320, the access monitoring unit 330, and the range determination unit 340 of the second example embodiment, respectively.

The user verification device 350 includes the user verification unit 360. The user verification unit 360 includes the action verification unit 310 and the authentication verification unit 410. The action verification unit 310 and the authentication verification unit 410 are the same as the action verification unit 310 and the authentication verification unit 410 of the second example embodiment, except that the action verification unit 310 and the authentication verification unit 410 are included in the user verification device 350.

The authentication device 400A includes the authentication unit 420. The authentication unit 420 is the same as the authentication unit 420 of the second example embodiment.

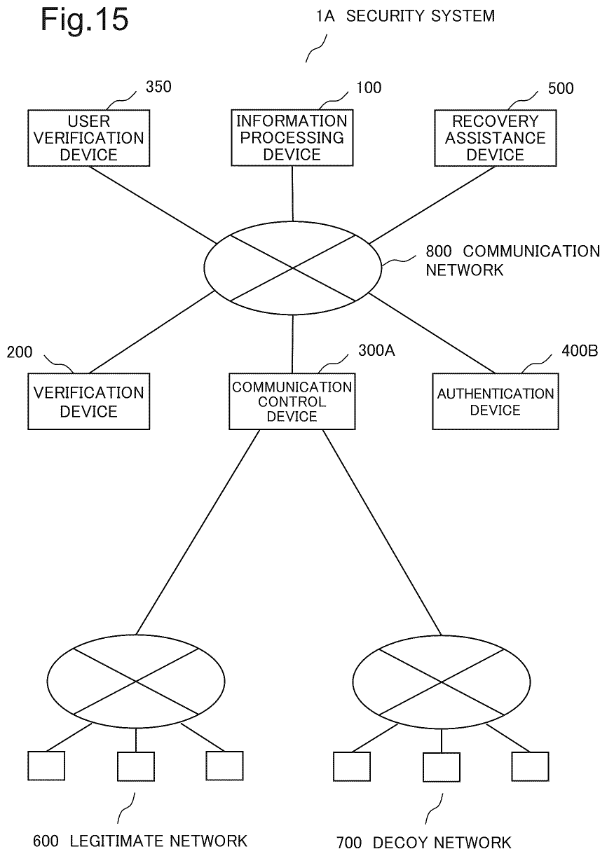

FIG. 15 is a block diagram schematically illustrating an example of a configuration of the security system according to the present disclosure.

In the security system 1A illustrated in FIG. 15, the information processing device 100, the verification device 200, the communication control device 300A, the user verification device 350, the authentication device 400A, and the restoration assistance device 500 are communicably connected to each other via a communication network 800.

### Third Example Embodiment

Next, the third example embodiment of the present disclosure will be described in detail with reference to the drawings.

### Configuration

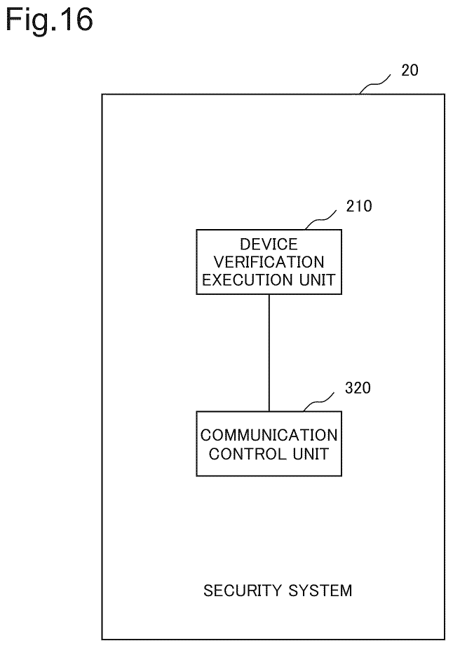

FIG. 16 is a block diagram illustrating an example of a configuration of a security system according to the present disclosure.

Hereinafter, a configuration of a security system according to the third example embodiment of the present disclosure will be described in detail with reference to FIG. 16.

In the example illustrated in FIG. 16, a security system 20 includes the device verification execution unit 210 and the communication control unit 320.

The device verification execution unit 210 verifies the device authenticity, which is the authenticity of the hardware of the information processing device that achieves the virtual computer, using the verification information generated from the information about starting up of the information processing device. The device verification execution unit 210 is related to the device verification execution unit 210 of the second example embodiment.

In a case where the device authenticity is not verified, the communication control unit 320 sets a communication partner of the virtual computer to a decoy network that mimics a connection destination of the virtual computer. The communication control unit 320 is related to the communication control unit 320 of the second example embodiment.

### Operation

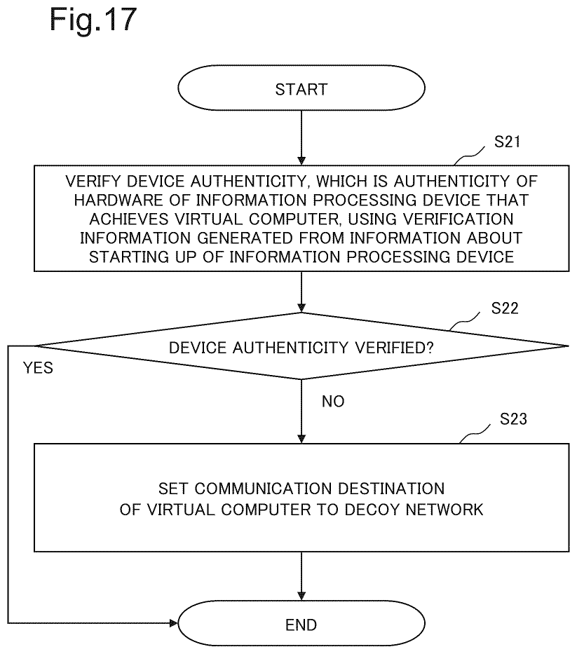

FIG. 17 is a flowchart illustrating an example of the operation of the security system according to the present disclosure.

Hereinafter, an operation of the security system 20 according to the third example embodiment of the present disclosure will be described in detail with reference to FIG. 17.

In the example illustrated in FIG. 17, first, the device verification execution unit 210 verifies the device authenticity, which is the authenticity of the hardware of the information processing device that achieves the virtual computer, using the verification information generated from the information about starting up of the information processing device (step S21). In a case where the device authenticity is verified (YES in step S22), the security system 20 ends the operation illustrated in FIG. 17. In a case where the device authenticity is not verified (NO in step S22), the communication control unit 320 sets the communication destination of the virtual computer to the decoy network (step S23).

### Effects

The present example embodiment has an effect of guiding an attack to an environment in which an attack by an attacker can be observed while preventing the attack by the attacker, as in the first example embodiment.

The reason is that the device verification execution unit 210 verifies the device authenticity of the information processing device that achieves the virtual computer. In a case where the device authenticity is not verified, the communication control unit 320 sets the communication partner of the virtual computer to the decoy network. Accordingly, in a case where the device authenticity is not verified, the access from the virtual computer is limited to the decoy network. Therefore, it is possible to prevent an attacker from attacking the legitimate network. In the decoy network, an attack to the decoy network can be observed from the virtual computer. That is, the security system of the present example embodiment can guide the attack to an environment in which the attack by the attacker can be observed while preventing the attack by the attacker.

### Second Modification of Second Example Embodiment

The information about the OS of the virtual computer 130 may be created in advance by the management system of the virtualization base. The information about the OS of the virtual computer 130 may be distributed (deployed) to the virtual computer. Specifically, for example, the information about the OS of the virtual computer 130 created in advance by the management system of the virtualization base may be stored in the information storage unit 520 of the restoration device. In this case, the reception unit 510 receives the information about the OS of the virtual computer 130 from the management system of the virtualization base, and stores the received information about the OS of the virtual computer 130 in the information storage unit 520. Upon receiving the instruction to transmit the information about the OS from the restoration unit 126, the transmission unit 530 reads the information about the OS of the virtual computer 130 from the information storage unit 520 to transmit the read information about the OS of the virtual computer 130 to the restoration unit 126. In this case, the hypervisor unit 120 may not include the information extraction unit 125. In this case, the restoration assistance device 500 may be part of the management system of the virtualization base described above.

### OTHER EXAMPLE EMBODIMENTS

A security system (in other words, the device according to the security system according to the example embodiment of the present disclosure) according to an example embodiment of the present disclosure can be achieved by a computer including a memory in which a program read from a storage medium is loaded and a processor that executes the program. The security system according to the example embodiment of the present disclosure can also be achieved by dedicated hardware. The security system according to the example embodiment of the present disclosure can also be achieved by a combination of the above-described computer and dedicated hardware. The devices according to the security system according to the example embodiment of the present disclosure are, for example, the information processing device, the verification device 200, the communication control device 300, the communication control device 300A, the user verification device 350, the authentication device 400, the authentication device 400A, the restoration assistance device 500, and the security device.

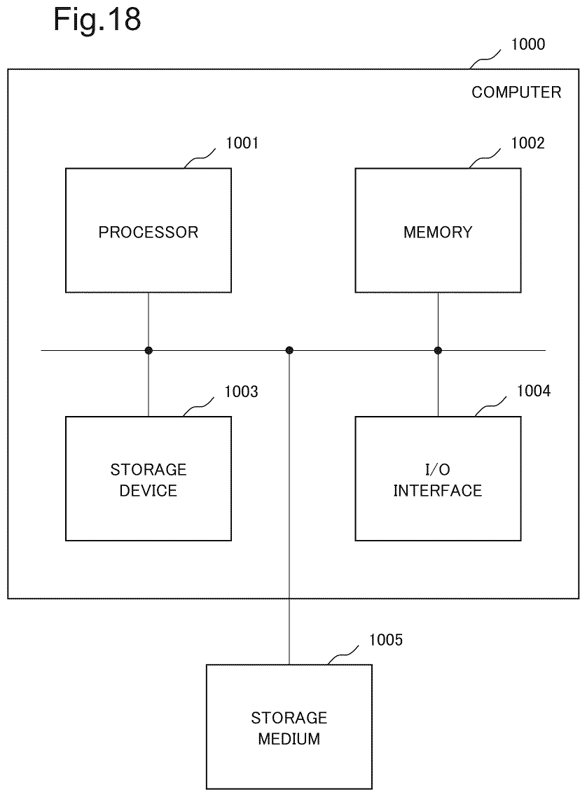

FIG. 18 is a diagram illustrating an example of a hardware configuration of a computer 1000 that can implement the security system according to the example embodiment of the present disclosure. The device according to the security system of the example embodiment of the present disclosure can be achieved using such a computer 1000. Referring to FIG. 18, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium.

The storage device 1003 may be the storage medium 1005. The processor 1001 can read and write data and programs from and in the memory 1002 and the storage device 1003. The processor 1001 can access, for example, other devices via the I/O interface 1004. The processor 1001 may access the storage medium 1005. The storage medium 1005 stores a program for operating the computer 1000 as a device according to the security system according to the example embodiment of the present disclosure.

The processor 1001 loads a program, which is stored in the storage medium 1005 and causes the computer 1000 to operate as a device according to the security system according to the example embodiment of the present disclosure, into the memory 1002. When the processor 1001 executes the program loaded in the memory 1002, the computer 1000 operates as a device according to the security system according to the example embodiment of the present disclosure.

The device verification execution unit 210, the action verification unit 310, the communication control unit 320, the access monitoring unit 330, the range determination unit 340, the user verification unit 360, the authentication verification unit 410, the authentication unit 420, the reception unit 510, and the transmission unit 530 can be achieved by, for example, the processor 1001 that executes a program loaded from the storage medium 1005 to the memory 1002. The starting up control unit 110, the hypervisor unit 120, the verification information generation unit 121, the device verification unit 122, the control instruction unit 123, the hypervisor execution unit 124, the information extraction unit 125, the restoration unit 126, and the virtual computer 130 can be achieved by, for example, the processor 1001 that executes a program loaded from the storage medium 1005 into the memory 1002.

The information storage unit 520 can be achieved by the memory 1002 or the storage device 1003 such as a nonvolatile memory included in the computer 1000. The virtual computer information storage unit 140 can be achieved by the memory 1002 or the storage device 1003 such as a nonvolatile memory included in the computer 1000.

Part or all of the device verification execution unit 210, the action verification unit 310, the communication control unit 320, the access monitoring unit 330, the range determination unit 340, the user verification unit 360, the authentication verification unit 410, the authentication unit 420, the reception unit 510, the information storage unit 520, and the transmission unit 530 can be achieved by a dedicated circuit that achieves the function of each unit. Part or all of the starting up control unit 110, the hypervisor unit 120, the verification information generation unit 121, the device verification unit 122, the control instruction unit 123, the hypervisor execution unit 124, the information extraction unit 125, the restoration unit 126, the virtual computer 130, and the virtual computer information storage unit 140 can be achieved by a dedicated circuit that achieves the function of each unit.

Some or all of the above example embodiments may be denoted as the following Supplementary Notes, but are not limited to the following.

When the administrator authority of an operating system (OS) of the information processing device is acquired by the attacker, there is a possibility that a security function such as an endpoint detection and response (EDR) is invalidated. There is a possibility that an attack on hardware such as rewriting of firmware is also performed. In this case, it is conceivable that it is difficult to detect the attack and cope with the attack.

The present disclosure has an effect of being able to guide an attack to an environment in which the attack by an attacker can be observed while preventing the attack by the attacker.

### Supplementary Note 1

A security system including
a device verification unit that verifies device authenticity that is authenticity of hardware of an information processing device that achieves a virtual computer using verification information generated from information about starting up of the information processing device, and
a control instruction unit that instructs a communication control device that controls communication from the virtual computer to set a communication partner of the virtual computer to a decoy network that mimics a connection destination of the virtual computer in a case where the device authenticity is not verified.

### Supplementary Note 2

The security system according to Supplementary Note 1, further including
a user verification unit that verifies, from an action of the user of the virtual computer, user authenticity that is authenticity of the user, wherein
in a case where the user authenticity of the user is not verified, the communication control device sets a communication partner of the virtual computer to the decoy network.

### Supplementary Note 3

The security system according to Supplementary Note 2, wherein
the user verification unit includes an authentication verification unit that verifies the user authenticity of the user using a result of authentication of the user.

### Supplementary Note 4

The security system according to Supplementary Note 3, wherein
the authentication verification unit determines that the user authenticity is not verified in a case where the user of the virtual computer fails in the authentication and in a case where the user who is not a registered user registered as a user of the virtual computer succeeds in the authentication, and determines that the user authenticity is verified in a case where the user who is a registered user registered as a user of the virtual computer succeeds in the authentication.

### Supplementary Note 5

The security system according to Supplementary Note 2, wherein
the user verification unit includes an action verification unit that verifies authenticity of the user using information about an access action, of the virtual computer, that is an action of accessing a resource of a network.

### Supplementary Note 6

The security system according to Supplementary Note 5, wherein
the action verification unit determines that the user authenticity of the user is not verified in a case where the access action of the virtual computer does not satisfy a predetermined action criterion, and determines that the user authenticity of the user is verified in a case where the access action of the virtual computer satisfies the predetermined action criterion.

### Supplementary Note 7

The security system according to Supplementary Note 5, wherein
the action verification unit determines that the user authenticity of the user is not verified in a case where the access action of the virtual computer is out of an access action range that is a range of the access action determined from the past access action of a registered user registered as a user of the virtual computer, and determines that the user authenticity of the user is verified in a case where the access action of the virtual computer is not out of the access action range.

### Supplementary Note 8

The security system according to Supplementary Note 7, further including
a range determination unit that determines the access action range from a history of the past access action of the virtual computer used by the registered user.

### Supplementary Note 9

The security system according to Supplementary Note 2 or 3, further including
an access monitoring unit that monitors an access action of the virtual computer, the access action being an action of accessing a resource of a network.

### Supplementary Note 10

The security system according to Supplementary Note 9, wherein
the access monitoring unit records a record of an access action of the virtual computer used by a registered user registered as a user of the virtual computer as a history of the access of the virtual computer used by the registered user.

### Supplementary Note 11

The security system according to Supplementary Note 9, wherein
the access monitoring unit records a record of an access action from the virtual computer to the decoy network as a record of an attack.

### Supplementary Note 12

The security system according to Supplementary Note 11, wherein
the access monitoring unit records a packet of communication from the virtual computer to the decoy network as a record of the attack.

### Supplementary Note 13

The security system according to Supplementary Note 1 or 2, further including
an information extraction unit that extracts OS information that is information about an operating system (OS) of the virtual computer,
an information storage unit that stores the OS information, and
a restoration unit that restores the OS of the virtual computer using the OS information read from the information storage unit in response to receiving a restoration instruction that is an instruction to restore the OS in a case where it is determined that the device authenticity is not verified.

### Supplementary Note 14

The security system according to Supplementary Note 2, further including
an information extraction unit that extracts OS information that is information about an operating system (OS) of the virtual computer,
an information storage unit that stores the OS information, and
a restoration unit that restores the OS of the virtual computer using the OS information read from the information storage unit in response to receiving a restoration instruction that is an instruction to restore the OS in a case where it is determined that at least any one of the device authenticity and the user authenticity is not verified.

### Supplementary Note 15

The security system according to Supplementary Note 1 or 2, including
the information processing device, a verification device, and the communication control device, wherein
the verification device includes
a device verification execution unit that verifies the device authenticity of the information processing device by comparing the received verification information with registration verification information that is verification information registered in advance of the information processing device in response to receiving the verification information,
the information processing device includes
a hypervisor unit that achieves the virtual computer,
the hypervisor unit includes
a verification information generation unit that generates the verification information about the information processing device from information about starting up of the information processing device,
a device verification unit that transmitting the verification information to the verification device,
a control instruction unit that transmits a decoy setting instruction to the communication control device that controls communication from the virtual computer in a case where the device authenticity is verified, the decoy setting instruction being an instruction to perform control to set a communication partner of the virtual computer to the decoy network, and
a hypervisor execution unit that executes a process of achieving the virtual computer after the decoy setting instruction is transmitted in a case where the device authenticity is verified, and
the communication control device includes
a communication control unit that sets a communication partner of the virtual computer to the decoy network in response to receiving the decoy setting instruction.

### Supplementary Note 16

The security system according to Supplementary Note 2 or 3, including
the information processing device, a verification device, the communication control device, and an authentication device, wherein
the verification device includes
a device verification execution unit that verifies the device authenticity of the information processing device by comparing the received verification information with registration verification information that is verification information registered in advance of the information processing device in response to receiving the verification information,
the information processing device includes
a hypervisor unit that achieves the virtual computer,
the hypervisor unit includes
a verification information generation unit that generates the verification information about the information processing device from information about starting up of the information processing device,
the device verification unit,
a control instruction unit that transmits a decoy setting instruction to the communication control device that controls communication from the virtual computer in a case where the device authenticity is verified, the decoy setting instruction being an instruction to perform control to set a communication partner of the virtual computer to the decoy network, and
a hypervisor execution unit that executes a process of achieving the virtual computer after the decoy setting instruction is transmitted in a case where the device authenticity is verified,
the device verification unit verifies the device authenticity of the information processing device by transmitting the verification information to the verification device,
the authentication device includes
an authentication verification unit that verifies the user authenticity of the user using a result of the authentication of the user, and transmits the decoy setting instruction to the communication control device in a case where it is determined that the user authenticity is not verified,
the communication control device includes
an action verification unit that verifies the user authenticity using information about an access action that is an action of the user to access a resource of a network, and
a communication control unit that sets a communication partner of the virtual computer to the decoy network in a case where it is determined that the user authenticity is not verified, and
the communication control unit sets a communication partner of the virtual computer to the decoy network in response to receiving the decoy setting instruction.

### Supplementary Note 17

A control device including
a device verification unit that verifies device authenticity that is authenticity of hardware of an information processing device that achieves a virtual computer using verification information generated from information about starting up of the information processing device, and
a control instruction unit that instructs a communication control device that controls communication from the virtual computer to perform control to set a communication partner of the virtual computer to a decoy network in a case where the device authenticity is not verified.

### Supplementary Note 18

The control device according to Supplementary Note 17, wherein
the device verification unit transmits the verification information about the information processing device to a verification device and receives information indicating whether the device authenticity is verified from the verification device, and
the verification device verifies the device authenticity of the information processing device by comparing the received verification information with registration verification information that is verification information registered in advance of the information processing device in response to receiving the verification information about the information processing device.

### Supplementary Note 19

A security method including
verifying device authenticity that is authenticity of hardware of an information processing device that achieves a virtual computer using verification information generated from information about starting up of the information processing device, and
instructing a communication control device that controls communication from the virtual computer to set a communication partner of the virtual computer to a decoy network that mimics a connection destination of the virtual computer in a case where the device authenticity is not verified.

### Supplementary Note 20

The security method according to Supplementary Note 19, further including
verifying, from an action of the user of the virtual computer, user authenticity that is authenticity of the user, wherein
in a case where the user authenticity of the user is not verified, the communication control device sets a communication partner of the virtual computer to the decoy network.

### Supplementary Note 21

The security method according to Supplementary Note 20, further including
verifying the user authenticity of the user using a result of authentication of the user.

### Supplementary Note 22

The security method according to Supplementary Note 21, further including
determining that the user authenticity is not verified in a case where the user of the virtual computer fails in the authentication and in a case where the user who is not a registered user registered as a user of the virtual computer succeeds in the authentication, and determining that the user authenticity is verified in a case where the user who is a registered user registered as a user of the virtual computer succeeds in the authentication.

### Supplementary Note 23

The security method according to Supplementary Note 20, further including
verifying authenticity of the user using information about an access action of the virtual computer, the access action being an action of accessing a resource of a network.

### Supplementary Note 24

The security method according to Supplementary Note 23, further including
determining that the user authenticity of the user is not verified in a case where the access action of the virtual computer does not satisfy a predetermined action criterion, and determining that the user authenticity of the user is verified in a case where the access action of the virtual computer satisfies the predetermined action criterion.

### Supplementary Note 25

The security method according to Supplementary Note 23, further including
determining that the user authenticity of the user is not verified in a case where the access action of the virtual computer is out of an access action range that is a range of the access action determined from the past access action of a registered user registered as a user of the virtual computer, and determining that the user authenticity of the user is verified in a case where the access action of the virtual computer is not out of the access action range.

### Supplementary Note 26

The security method according to Supplementary Note 25, further including
determining the access action range from a history of the past access action of the virtual computer used by the registered user.

### Supplementary Note 27

The security method according to Supplementary Note 20 or 21, further including
monitoring an access action that is an action of accessing a resource of a network by the virtual computer.

### Supplementary Note 28

The security method according to Supplementary Note 27, further including
recording a record of an access action of the virtual computer used by a registered user registered as a user of the virtual computer as a history of the access of the virtual computer used by the registered user.

### Supplementary Note 29

The security method according to Supplementary Note 27, further including
recording a record of an access action from the virtual computer to the decoy network as a record of an attack.

### Supplementary Note 30

The security method according to Supplementary Note 29, further including
recording a packet of communication from the virtual computer to the decoy network as a record of the attack.

### Supplementary Note 31

The security method according to Supplementary Note 19 or 20, further including
extracting OS information that is information about an operating system (OS) of the virtual computer,
storing the OS information in an information storage unit and
restoring the OS of the virtual computer using the OS information read from the information storage unit in response to receiving a restoration instruction that is an instruction to restore the OS in a case where it is determined that the device authenticity is not verified.

### Supplementary Note 32

The security method according to Supplementary Note 20, further including
extracting OS information that is information about an operating system (OS) of the virtual computer,
storing the OS information in an information storage unit, and
restoring the OS of the virtual computer using the OS information read from the information storage unit in response to receiving a restoration instruction that is an instruction to restore the OS in a case where it is determined that at least any one of the device authenticity and the user authenticity is not verified.

### Supplementary Note 33

The security method according to Supplementary Note 19 or 20, wherein
a verification device
verifies the device authenticity of the information processing device by comparing the received verification information with registration verification information that is verification information registered in advance of the information processing device in response to receiving the verification information,
the information processing device
generates the verification information about the information processing device from information about starting up of the information processing device,
transmits the verification information to the verification device,
transmits, in a case where the device authenticity is verified, a decoy setting instruction to the communication control device that controls communication from the virtual computer, the decoy setting instruction being an instruction to perform control to set a communication partner of the virtual computer to the decoy network, and
executes a process of achieving the virtual computer after the decoy setting instruction is transmitted in a case where the device authenticity is verified, and
the communication control device
sets a communication partner of the virtual computer to the decoy network in response to receiving the decoy setting instruction.

### Supplementary Note 34

The security method according to Supplementary Note 20 or 21, wherein
a verification device
verifies the device authenticity of the information processing device by comparing the received verification information with registration verification information that is verification information registered in advance of the information processing device in response to receiving the verification information,
the information processing device
generates the verification information about the information processing device from information about starting up of the information processing device,
transmits, in a case where the device authenticity is verified, a decoy setting instruction to the communication control device that controls communication from the virtual computer, the decoy setting instruction being an instruction to perform control to set a communication partner of the virtual computer to the decoy network,
executes a process of achieving the virtual computer after the decoy setting instruction is transmitted in a case where the device authenticity is verified, and
verifies the device authenticity of the information processing device by transmitting the verification information to the verification device,
an authentication device
verifies the user authenticity of the user using a result of the authentication of the user, and transmits the decoy setting instruction to the communication control device in a case where it is determined that the user authenticity is not verified, and
the communication control device
verifies the user authenticity using information about an access action that is an action of the user to access a resource of a network,
sets a communication partner of the virtual computer to the decoy network in a case where it is determined that the user authenticity is not verified, and
sets a communication partner of the virtual computer to the decoy network in response to receiving the decoy setting instruction.

### Supplementary Note 35

A control method including
verifying device authenticity that is authenticity of hardware of an information processing device that achieves a virtual computer using verification information generated from information about starting up of the information processing device, and
instructing a communication control device that controls communication from the virtual computer to perform control to set a communication partner of the virtual computer to a decoy network in a case where the device authenticity is not verified.

### Supplementary Note 36

The control method according to Supplementary Note 35, further including
transmitting the verification information about the information processing device to a verification device and receiving information indicating whether the device authenticity is verified from the verification device, wherein
the verification device verifies the device authenticity of the information processing device by comparing the received verification information with registration verification information that is verification information registered in advance of the information processing device in response to receiving the verification information about the information processing device.

### Supplementary Note 37

A program for causing a computer to execute
a device verification process of verifying device authenticity that is authenticity of hardware of an information processing device that achieves a virtual computer using verification information generated from information about starting up of the information processing device, and
a control instruction process of instructing a communication control device that controls communication from the virtual computer to set a communication partner of the virtual computer to a decoy network that mimics a connection destination of the virtual computer in a case where the device authenticity is not verified.

### Supplementary Note 38

The program according to Supplementary Note 37, wherein
the device verification process includes transmitting the verification information about the information processing device to a verification device and receives information indicating whether the device authenticity is verified from the verification device, and
the verification device verifies the device authenticity of the information processing device by comparing the received verification information with registration verification information that is verification information registered in advance of the information processing device in response to receiving the verification information about the information processing device.

### Supplementary Note 39

A security system including
a device verification execution unit that verifies device authenticity that is authenticity of hardware of an information processing device that achieves a virtual computer using verification information generated from information about starting up of the information processing device, and
a communication control unit that sets a communication partner of the virtual computer to a decoy network that mimics a connection destination of the virtual computer in a case where the device authenticity is not verified.

### Supplementary Note 40

A security method including
verifying device authenticity that is authenticity of hardware of an information processing device that achieves a virtual computer using verification information generated from information about starting up of the information processing device, and
setting a communication partner of the virtual computer to a decoy network that mimics a connection destination of the virtual computer in a case where the device authenticity is not verified.

### Supplementary Note 41

A program for causing a computer to execute
a device verification execution process of verifying device authenticity that is authenticity of hardware of an information processing device that achieves a virtual computer using verification information generated from information about starting up of the information processing device, and
a communication control process of setting a communication partner of the virtual computer to a decoy network that mimics a connection destination of the virtual computer in a case where the device authenticity is not verified.

While the present disclosure has been particularly illustrated and described with reference to example embodiments thereof, the present disclosure is not limited to these example embodiments. Various modifications that can be understood by those of ordinary skill in the art can be made to the configuration and details of the present disclosure within the scope of the present disclosure.

What is claimed is:

1. A security system comprising:
at least one memory storing a set of instructions; and
at least one processor configured to execute the set of instructions to:
verify device authenticity by using verification information, the device authenticity being authenticity of hardware of an information processing device that achieves a virtual computer, the verification information being generated from information about activation of the information processing device; and
instruct a communication control device that controls communication from the virtual computer to set a communication partner of the virtual computer to a decoy network in a case where the device authenticity is not verified, the decoy network imitating a connection destination of the virtual computer.

2. The security system according to claim 1, wherein
the at least one processor is further configured to execute the instructions to
verify, from an action of a user of the virtual computer, user authenticity that is authenticity of the user, wherein
the communication control device sets a communication partner of the virtual computer to the decoy network in a case where the user authenticity of the user is not verified.

3. The security system according to claim 2, wherein
the at least one processor is further configured to execute the instructions to
verify the user authenticity of the user using a result of authentication of the user.

4. The security system according to claim 3, wherein
the at least one processor is further configured to execute the instructions to:
determine, that the user authenticity is not verified in a case where the user of the virtual computer fails in the authentication and in a case where the user who is not a registered user registered as a user of the virtual computer succeeds in the authentication; and
determine that the user authenticity is verified in a case where the user who is a registered user registered as a user of the virtual computer succeeds in the authentication.

5. The security system according to claim 2, wherein
the at least one processor is further configured to execute the instructions to
verify authenticity of the user using information about an access action of the virtual computer, the access action being an action of accessing a resource of a network.

6. The security system according to claim 5, wherein
the at least one processor is further configured to execute the instructions to:
determine that the user authenticity of the user is not verified in a case where the access action of the virtual computer does not satisfy a predetermined action criterion; and
determine that the user authenticity of the user is verified in a case where the access action of the virtual computer satisfies the predetermined action criterion.

7. The security system according to claim 5, wherein
the at least one processor is further configured to execute the instructions to:
determine that the user authenticity of the user is not verified in a case where the access action of the virtual computer is out of an access action range that is a range of the access action determined from a past access action of a registered user who is registered as a user of the virtual computer; and
determine that the user authenticity of the user is verified in a case where the access action of the virtual computer is not out of the access action range.

8. The security system according to claim 7, wherein
the at least one processor is further configured to execute the instructions to
determine the access action range from a history of a past access action of the virtual computer used by the registered user.

9. The security system according to claim 2, wherein
the at least one processor is further configured to execute the instructions to
monitor an access action of the virtual computer, the access action being an action of accessing a resource of a network.

10. The security system according to claim 9, wherein
the at least one processor is further configured to execute the instructions to
record a record of an access action of the virtual computer used by a registered user registered as a user of the virtual computer as a history of the access of the virtual computer used by the registered user.

11. The security system according to claim 9, wherein
the at least one processor is further configured to execute the instructions to
record a record of an access action from the virtual computer to the decoy network as a record of an attack.

12. The security system according to claim 11, wherein
the at least one processor is further configured to execute the instructions to
record a packet of communication from the virtual computer to the decoy network as a record of the attack.

13. The security system according to claim 1, wherein
the at least one memory stores operating system (OS) information that is information about an OS of the virtual computer, and
the at least one processor is further configured to execute the instructions to:
extract the OS information; and
restore the OS of the virtual computer using the OS information read from the at least one memory in response to receiving a restoration instruction that is an instruction to restore the OS in a case where it is determined that the device authenticity is not verified.

14. The security system according to claim 2, further including
the at least one memory stores operating system (OS) information that is information about an OS of the virtual computer, and
the at least one processor is further configured to execute the instructions to:
extract the OS information; and
restore the OS of the virtual computer using the OS information read from the at least one memory in response to receiving a restoration instruction that is an instruction to restore the OS in a case where it is determined that at least any one of the device authenticity and the user authenticity is not verified.

15. A control device comprising:
at least one memory storing a set of instructions; and
at least one processor configured to execute the set of instructions to:
verify device authenticity that is authenticity of hardware of an information processing device that achieves a virtual computer using verification information generated from information about starting up of the information processing device; and
instruct a communication control device that controls communication from the virtual computer to perform control to set a communication partner of the virtual computer to a decoy network in a case where the device authenticity is not verified.

16. The control device according to claim 15, wherein
the at least one processor is further configured to execute the instructions to:
transmit the verification information about the information processing device to a verification device and receives information indicating whether the device authenticity is verified from the verification device; and
verify the device authenticity of the information processing device by comparing the received verification information with registration verification information that is verification information registered in advance of the information processing device in response to receiving the verification information about the information processing device.

17. A security method comprising:
verifying device authenticity by using verification information, the device authenticity being authenticity of hardware of an information processing device that achieves a virtual computer, the verification information being generated from information about activation of the information processing device; and
instructing a communication control device that controls communication from the virtual computer to set a communication partner of the virtual computer to a decoy network in a case where the device authenticity is not verified, the decoy network imitating a connection destination of the virtual computer.

18. The security method according to claim 17, further comprising:
verifying, from an action of a user of the virtual computer, user authenticity that is authenticity of the user; and
setting a communication partner of the virtual computer to the decoy network in a case where the user authenticity of the user is not verified.

19. The security method according to claim 18, further comprising
verifying the user authenticity of the user using a result of authentication of the user.

20. The security method according to claim 19, further comprising:
determining that the user authenticity is not verified in a case where the user of the virtual computer fails in the authentication and in a case where the user who is not a registered user registered as a user of the virtual computer succeeds in the authentication; and
determining that the user authenticity is verified in a case where the user who is a registered user registered as a user of the virtual computer succeeds in the authentication.
